(19) United States
(12) Patent Application Publication
(10) Pub. No.: US 2026/0228644 A1
(43) Pub. Date: Aug. 6, 2026

(54) MULTI-SOURCE DATA AND EXPLAINABLE MACHINE LEARNING SYSTEMS AND METHODS

(71) Applicant: WORKDAY, INC., Pleasanton, CA (US)

(72) Inventors: Nitin BHATNAGAR, San Ramon, CA (US); Bert HARO, Oakland, CA (US)

(21) Appl. No.: 19/042,591

(22) Filed: Jan. 31, 2025

(51) Int. Cl. G06N 20/20

(52) U.S. Cl. CPC G06N 20/20

(57) ABSTRACT

In some implementations, the techniques described herein relate to a method including: receiving data from a plurality of heterogeneous data sources; processing each type of received data through a corresponding type-specific processing pipeline by performing temporal pattern extraction specific to each data type; generating cross-source feature vectors by performing temporal correlation analysis across the processed data from different data sources; training an ensemble machine learning model using the cross-source feature vectors; generating engagement predictions and feature contribution values that quantify an impact of each feature on each prediction; presenting the engagement predictions with natural language explanations based on the feature contribution values; and updating weights of the ensemble machine learning model based on user feedback regarding the natural language explanations.

### BACKGROUND

Systems for analyzing time-series data from multiple sources face significant technical challenges in data integration and pattern recognition. Traditional approaches to processing multi-source data have relied on batch analysis of structured data tables, manual review of text records, and simple statistical aggregation of event logs. These methods typically process each data stream independently, failing to capture complex interactions between different data types and temporal patterns. Such systems often suffer from high latency between data collection and analysis, limiting their ability to detect significant pattern changes until well after they occur. The technical limitations of these systems stem from their inability to handle heterogeneous data formats, difficulties in maintaining temporal consistency across different data streams, and computational constraints in processing high-dimensional feature spaces efficiently.

### BRIEF DESCRIPTION OF THE DRAWINGS

FIG. 1 is a block diagram illustrating a user engagement analysis system according to some of the disclosed embodiments.

FIG. 2 is a flow diagram illustrating a method for processing and generating machine learning features from multi-source user data according to some of the disclosed embodiments.

FIG. 3 is a flow diagram illustrating a method for training and deploying user engagement prediction models according to some of the disclosed embodiments.

FIG. 4 is a flow diagram illustrating a method for generating and explaining user engagement predictions according to some of the disclosed embodiments.

FIG. 5 is a block diagram of a computing device according to some embodiments of the disclosure.

### DETAILED DESCRIPTION

Existing solutions for data analytics generally fall into two categories: rule-based systems that use predetermined thresholds and statistical models that analyze historical patterns. Rule-based systems require constant manual updating of rules and thresholds, making them difficult to maintain as business conditions change. Statistical models, while more automated, typically focus on a limited set of indicators and struggle to capture complex interactions between different aspects of user behavior.

Many existing approaches also lack transparency in their decision-making process, making it difficult for business users to understand and trust the system's predictions. This can lead to reduced adoption of analytical tools and missed opportunities for early intervention with at-risk users.

Thus, there is a need for improved systems and methods for processing multi-source temporal data streams that can efficiently handle heterogeneous data formats, capture complex cross-stream interactions, and generate interpretable results from high-dimensional feature spaces while maintaining real-time processing capabilities.

As one example, the challenge of predicting user interaction levels lies in the complexity and diversity of user behavior data. Traditional systems struggle to process and analyze data from numerous disparate sources, each with different formats, update frequencies, and noise characteristics. Furthermore, the relationships between different types of user interactions are often non-linear and time-dependent, making it difficult to identify meaningful patterns. Even when patterns are found, existing solutions typically operate as black boxes, providing predictions without describing the underlying rationale, which limits their practical utility for end users who need to take action based on these predictions. The technical complexity is compounded by the need to continuously adapt to changing user behavior patterns while maintaining system stability and prediction accuracy.

The disclosed system addresses these technical challenges through a multi-stage architecture that implements dedicated processing pipelines for different data types, coupled with a feature engineering system that captures temporal patterns and cross-source correlations. The system employs an ensemble approach that combines multiple machine learning models, each optimized for specific aspects of the prediction task, with an automated weight optimization process that ensures optimum performance across different user segments. One technical implementation includes a feature store that maintains point-in-time correctness for all features, ensuring that predictions don't inadvertently use future data, while supporting both batch and real-time prediction paths. In some implementations, the system's explainability is achieved through a SHAP value calculation pipeline that processes complex ensemble model outputs to generate interpretable explanations, with optimizations to handle the computational complexity of exact Shapley calculations. In some implementations, a feedback processing subsystem enables continuous improvement through structured weight updates and training data modifications, while maintaining safeguards against feedback-induced instability. This technical architecture enables the system to process diverse data streams efficiently, generate accurate predictions, and provide explainable results while automatically adapting to changing patterns in user behavior.

A system and method for predicting user engagement using multi-source data and explainable machine learning are described herein. In some implementations, the method includes receiving data from multiple internal and external data sources, processing the data through source-specific pipelines, and performing feature engineering to generate feature vectors. An ensemble of machine learning models is trained using these feature vectors and generates predictions about user engagement. The system calculates feature importance values for the predictions and generates natural language explanations to help users understand the factors driving each prediction. User feedback is collected on both the predictions and their explanations, which is then processed to generate model updates. The ensemble models are continuously improved based on this processed feedback, creating a cycle of refinement that enhances prediction accuracy while maintaining explainability. The method includes dedicated processing for different data types, temporal analysis, pattern detection, and correlation analysis across data sources. The ensemble modeling approach combines multiple machine learning models trained in parallel, with optimized weighting of their outputs to achieve superior predictive performance while providing interpretable results that can drive business decisions.

In some implementations, the techniques described herein relate to a method including: receiving data from a plurality of heterogeneous data sources; processing each type of received data through a corresponding type-specific processing pipeline by performing temporal pattern extraction specific to each data type; generating cross-source feature vectors by performing temporal correlation analysis across the processed data from different data sources; training an ensemble machine learning model using the cross-source feature vectors; generating engagement predictions and feature contribution values that quantify an impact of each feature on each prediction; presenting the engagement predictions with natural language explanations based on the feature contribution values; and updating weights of the ensemble machine learning model based on user feedback regarding the natural language explanations.

In some implementations, the techniques described herein relate to a method, wherein processing each type of received data includes: extracting time-based behavioral patterns specific to each data source type; generating source-specific engagement metrics; and normalizing the metrics across different time scales.

In some implementations, the techniques described herein relate to a method, wherein generating cross-source feature vectors includes: identifying correlations between events across different data sources; detecting temporal sequences that span multiple data sources; and generating features that capture cross-source interaction patterns.

In some implementations, the techniques described herein relate to a method, wherein training the ensemble machine learning model includes: training multiple model types optimized for different aspects of user behavior; combining outputs of the models using dynamically adjusted weights; and validating combined model performance across different user segments.

In some implementations, the techniques described herein relate to a method, wherein generating the feature contribution values includes: calculating an impact of each feature on the prediction; aggregating feature impacts across different time windows; and generating relative importance rankings for features from each data source.

In some implementations, the techniques described herein relate to a method, wherein updating weights of the ensemble model includes: processing structured and unstructured user feedback on the explanations; adjusting feature importance weights based on the processed feedback; and retraining the ensemble model using the adjusted weights.

In some implementations, the techniques described herein relate to a method, wherein presenting the engagement predictions includes: generating different levels of explanation detail for different user types; highlighting most significant cross-source patterns; and providing interactive exploration of feature contributions.

In some implementations, the techniques described herein relate to a non-transitory computer-readable storage medium for tangibly storing computer program instructions capable of being executed by a computer processor, the computer program instructions defining steps of: receiving data from a plurality of heterogeneous data sources; processing each type of received data through a corresponding type-specific processing pipeline by performing temporal pattern extraction specific to each data type; generating cross-source feature vectors by performing temporal correlation analysis across the processed data from different data sources; training an ensemble machine learning model using the cross-source feature vectors; generating engagement predictions and feature contribution values that quantify an impact of each feature on each prediction; presenting the engagement predictions with natural language explanations based on the feature contribution values; and updating weights of the ensemble machine learning model based on user feedback regarding the natural language explanations.

In some implementations, the techniques described herein relate to a non-transitory computer-readable storage medium, wherein processing each type of received data includes: extracting time-based behavioral patterns specific to each data source type; generating source-specific engagement metrics; and normalizing the metrics across different time scales.

In some implementations, the techniques described herein relate to a non-transitory computer-readable storage medium, wherein generating cross-source feature vectors includes: identifying correlations between events across different data sources; detecting temporal sequences that span multiple data sources; and generating features that capture cross-source interaction patterns.

In some implementations, the techniques described herein relate to a non-transitory computer-readable storage medium, wherein training the ensemble machine learning model includes: training multiple model types optimized for different aspects of user behavior; combining outputs of the models using dynamically adjusted weights; and validating combined model performance across different user segments.

In some implementations, the techniques described herein relate to a non-transitory computer-readable storage medium, wherein generating the feature contribution values includes: calculating an impact of each feature on the prediction; aggregating feature impacts across different time windows; and generating relative importance rankings for features from each data source.

In some implementations, the techniques described herein relate to a non-transitory computer-readable storage medium, wherein updating weights of the ensemble model includes: processing structured and unstructured user feedback on the explanations; adjusting feature importance weights based on the processed feedback; and retraining the ensemble model using the adjusted weights.

In some implementations, the techniques described herein relate to a non-transitory computer-readable storage medium, wherein presenting the engagement predictions includes: generating different levels of explanation detail for different user types; highlighting most significant cross-source patterns; and providing interactive exploration of feature contributions.

In some implementations, the techniques described herein relate to a device including: a processor; a storage medium for tangibly storing thereon program logic for execution by the processor, the program logic including steps for: receiving data from a plurality of heterogeneous data sources; processing each type of received data through a corresponding type-specific processing pipeline by performing temporal pattern extraction specific to each data type; generating cross-source feature vectors by performing temporal correlation analysis across the processed data from different data sources; training an ensemble machine learning model using the cross-source feature vectors; generating engagement predictions and feature contribution values that quantify an impact of each feature on each prediction; presenting the engagement predictions with natural language explanations based on the feature contribution values; and updating weights of the ensemble machine learning model based on user feedback regarding the natural language explanations.

In some implementations, the techniques described herein relate to a device, wherein processing each type of received data includes: extracting time-based behavioral patterns specific to each data source type; generating source-specific engagement metrics; and normalizing the metrics across different time scales.

In some implementations, the techniques described herein relate to a device, wherein generating cross-source feature vectors includes: identifying correlations between events across different data sources; detecting temporal sequences that span multiple data sources; and generating features that capture cross-source interaction patterns.

In some implementations, the techniques described herein relate to a device, wherein training the ensemble machine learning model includes: training multiple model types optimized for different aspects of user behavior; combining outputs of the models using dynamically adjusted weights; and validating combined model performance across different user segments.

In some implementations, the techniques described herein relate to a device, wherein generating the feature contribution values includes: calculating an impact of each feature on the prediction; aggregating feature impacts across different time windows; and generating relative importance rankings for features from each data source.

In some implementations, the techniques described herein relate to a device, wherein updating weights of the ensemble model includes: processing structured and unstructured user feedback on the explanations; adjusting feature importance weights based on the processed feedback; and retraining the ensemble model using the adjusted weights.

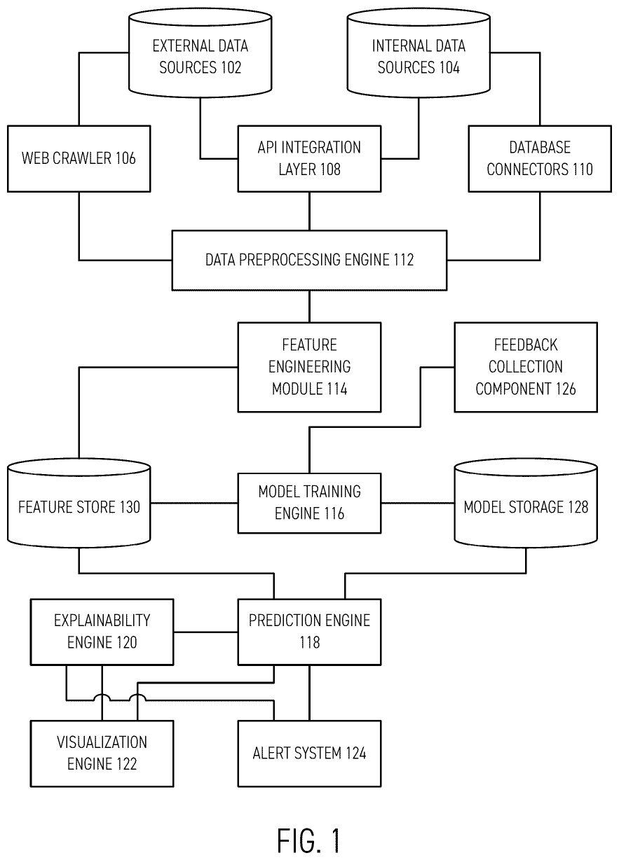

FIG. 1 is a block diagram illustrating a user engagement analysis system according to some of the disclosed embodiments.

In the illustrated embodiment, the system includes both external data sources 102 and internal data sources 104. External data sources 102 may comprise third-party data providers and publicly available data sources that contain information about user behavior, market trends, and competitive intelligence. For example, external data sources 102 may include data from providers that track user web activity and search patterns across hundreds of topics, social media sentiment analysis, and industry review platforms. Internal data sources 104 may include proprietary company databases containing user interaction records, financial data, product usage statistics, and support ticket information. These internal sources can include user satisfaction (CSAT) scores, Net Promoter Score (NPS) surveys, product usage logs, user support case histories, and financial transaction records.

In some implementations, web activity data processing includes specialized handling of third-party intent data. For example, when processing data from intent tracking providers, the system may receive up to 500 different tracked topics per customer, requiring efficient filtering and categorization. The processing pipeline implements topic relevance scoring to identify which topics are meaningful for prediction, using techniques such as correlation analysis with known customer outcomes and domain-specific filtering rules. For each relevant topic, the system tracks metrics including search velocity (rate of searches over time), dwell time on related content, and interaction depth across multiple channels.

In some implementations, customer satisfaction data processing includes specialized handling of survey responses and scoring systems. The system processes both periodic CSAT surveys and transactional NPS responses, implementing different temporal aggregation strategies for each type. For CSAT data, the system maintains separate tracking for different product areas and user roles, enabling granular analysis of satisfaction trends. The processing pipeline includes mechanisms to handle survey timing effects, such as adjusting for response delays and implementing decay factors for older responses. The system also tracks meta-metrics about survey responses, such as response rates and completion patterns, which can themselves be predictive features.

In some implementations, stakeholder tracking includes specialized processing for organizational relationships and movement patterns. The system maintains a graph structure of key stakeholders within customer organizations, tracking attributes such as role changes, product experience levels, and historical interactions. When processing stakeholder data, the system implements detection mechanisms for significant events such as champion movement between companies or role changes that affect product interaction patterns. The processing pipeline includes mechanisms to propagate stakeholder influence across the organization graph, enabling the system to model how individual stakeholders impact overall customer engagement.

For each data source type, the system maintains separate validation rules and quality metrics. For example: web activity data is validated for completeness across different tracking channels and checked for anomalous pattern changes that might indicate tracking issues, survey data is validated for statistical significance within different customer segments and checked for response bias patterns, and stakeholder data is validated for consistency across different organizational levels and checked for completeness of relationship mapping. The system implements source-specific retry logic and fallback processing for each data type. For example, if real-time web activity data is temporarily unavailable, the system can fall back to batch processing of historical data while maintaining the overall prediction pipeline operation.

The system includes multiple data collection components for gathering information from these sources. A web crawler 106 systematically accesses and processes information from external data sources 102, focusing on relevant user sentiment indicators and market signals. The web crawler 106 can be configured to identify and extract specific keywords and patterns that indicate user satisfaction, competitor interest, or potential churn risk. An API integration layer 108 facilitates standardized data exchange with both external data sources 102 and internal data sources 104, enabling real-time data collection through documented interfaces. The API integration layer 108 layer supports both REST and GraphQL protocols, with built-in rate limiting and error handling to ensure reliable data collection. Database connectors 110 provide direct access to internal data sources 104, allowing efficient extraction of structured data from company databases. These connectors support multiple database types including SQL, NoSQL, and time-series databases, with capabilities for incremental data loading and change data capture.

A data preprocessing engine 112 receives raw data from the collection components and performs initial cleaning and standardization operations. In some implementations, data preprocessing engine 112 handles tasks such as removing duplicate records, standardizing date formats, and dealing with missing values. The engine also performs data validation, checking for data quality issues such as outliers, inconsistent values, and unexpected patterns. The preprocessed data is then passed to a feature engineering module 114, which transforms the raw data into features suitable for machine learning analysis. Feature engineering module 114 may perform operations such as calculating temporal patterns, generating aggregate statistics, and creating derived metrics that capture complex relationships in the data. For example, it might compute metrics like user engagement velocity, relative usage compared to similar users, or trend indicators for support ticket frequency.

The system includes a feature store 130 that serves as a centralized repository for the engineered features. Feature store 130 may implement version control and feature serving capabilities to ensure consistent feature definitions across different models and applications. In some implementations, feature store 130 may also cache commonly used feature combinations to improve system performance. The feature store maintains point-in-time correctness for all features, ensuring that predictions don't inadvertently use future data, and supports both batch and real-time feature serving paths.

A model training engine 116 uses the prepared features to train machine learning models for user engagement prediction. These models may include, without limitation, gradient boosted trees, neural networks, and ensemble models combining multiple approaches. The training engine supports both automated hyperparameter optimization and A/B testing of different model architectures. Trained models are stored in model storage 128, which maintains version history and model metadata to support reproducibility and rollback capabilities if needed. Model storage 128 also tracks model performance metrics and can automatically archive older versions when newer models demonstrate superior performance.

A prediction engine 118 applies the trained models to generate user engagement scores and predictions. In some implementations, prediction engine 118 may execute multiple models in parallel and combine their outputs using ensemble techniques. The prediction engine 118 receives features from feature store 130 and model parameters from model storage 128 to generate its predictions. It can operate in both batch mode for regular reporting and real-time mode for immediate predictions on incoming data.

An explainability engine 120 processes the model outputs to provide interpretable results. In some implementations, explainability engine 120 may use techniques such as SHAP (SHapley Additive exPlanations) values to break down which factors contributed to each prediction and to what degree. The engine can generate both global explanations of model behavior and local explanations for individual predictions, helping users understand both overall patterns and specific cases. This helps users understand why particular predictions were made and builds trust in the system's outputs.

The system includes several output components for delivering results to end users. A visualization engine 122 generates interactive displays of the analysis results, allowing users to explore predictions and their explanations through various charts and graphs. The visualizations can be customized for different user roles, with executives seeing high-level dashboards while analysts can access detailed drill-down views. An alert system 124 monitors predictions and notifies relevant stakeholders when certain conditions are met, such as when a user's engagement score drops below a threshold or shows a concerning trend. Alerts can be configured with different severity levels and delivered through multiple channels including email, SMS, and integration with existing workflow systems.

Feedback collection component 126 can receive user feedback on the system's predictions and explanations from client devices (not illustrated) that receive visualizations or alerts from visualization engine 122 and alert system 124, respectively. This feedback can be used to improve model performance through regular retraining cycles. In some implementations, feedback collection component 126 may support both high-level feedback (e.g., whether a prediction was accurate) and detailed feedback about specific features or model components. The feedback system can also capture contextual information about why a prediction might have been incorrect, helping to identify systematic errors or gaps in the model's understanding.

The system implements a feedback loop where collected feedback flows back to the model training engine 116, enabling continuous improvement of the models based on real-world performance. The feedback loop includes automated validation checks to ensure that model updates actually improve performance across all important metrics before being deployed to production.

In operation, the system continuously collects and processes data from multiple sources, generates predictions about user engagement, explains those predictions to users, and improves its performance based on feedback. The modular architecture allows for components to be updated or replaced independently as requirements evolve or new technologies become available. The system can scale to handle large volumes of data and can be configured to focus on different aspects of user engagement depending on business needs. By combining multiple data sources and sophisticated machine learning techniques, the system provides a comprehensive view of user engagement that can drive strategic decision-making across sales, marketing, and user success teams.

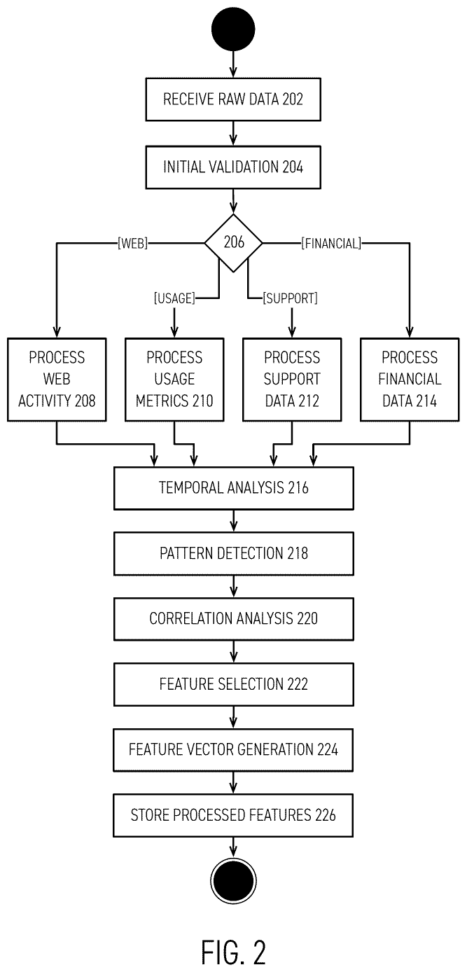

FIG. 2 is a flow diagram illustrating a method for processing and generating machine learning features from multi-source user data according to some of the disclosed embodiments.

In step 202, the method includes receiving raw data from various data sources. In some implementations, this raw data may comprise unstructured or semi-structured information from multiple sources including, without limitation, web activity data from third-party providers, internal product usage logs, user support tickets, and financial transaction records. The raw data may arrive through various interfaces including API endpoints, database connections, or scheduled file uploads. The data collection process may operate in both batch mode, processing data at fixed intervals, and streaming mode for real-time data ingestion.

In step 204, the method performs initial validation of the incoming data format. This validation step comprises checking for required fields, verifying data types, and ensuring data consistency across sources. In some implementations, the validation process applies source-specific schemas and rule sets. For example, financial data may require specific numerical formats and date ranges, while web activity data must conform to predetermined log formats. The validation step may also check for data completeness and flag any missing or corrupted records for special handling.

In step 206, the method performs a data type check to route different categories of data to appropriate processing pipelines. The type check examines incoming data characteristics including, without limitation, source identifiers, content patterns, and metadata to determine the correct processing path. This routing mechanism ensures that each data type receives dedicated processing optimized for its particular characteristics and requirements. Based on the data type determination, the method routes data through source-specific processing. The specific processing will thus vary, as exemplified herein, based on the type of data. Although three types are discussed, the disclosure is not limited as such.

In step 208, for web activity data, the method processes raw web logs through operations including, without limitation, sessionization, keyword extraction, and engagement metric calculation. The sessionization process involves grouping sequential user actions into coherent sessions using configurable time thresholds and state management. For keyword extraction, the method employs natural language processing techniques to identify and categorize relevant terms, particularly focusing on product names, competitor mentions, and intent signals. The web activity processor may analyze complex data streams such as user intelligence data, which tracks hundreds of intent topics across multiple channels. For each topic, the processor calculates normalized engagement scores based on factors including visit frequency, dwell time, and interaction depth. The processor maintains rolling averages and trend indicators for each topic to detect significant changes in user interest patterns.

In step 210, the method can process usage metric data. In some implementations, this can involve analyzing product interaction data through operations including, without limitation, calculating adoption rates, feature utilization statistics, and usage trend analysis. The usage processor examines both real-time events and historical patterns to build a comprehensive view of product engagement. The processor implements sliding window calculations to maintain moving averages and variance metrics for different usage indicators. Feature utilization analysis includes measuring the breadth and depth of feature usage, tracking the progression through feature complexity levels, and identifying usage patterns associated with successful user outcomes. This may include analyzing specific feature usage patterns that distinguish highly engaged users from those at risk of churning, such as changes in login frequency, feature abandonment patterns, and adoption of advanced functionality. The processor maintains separate models for different user segments and product types to account for varying expected usage patterns.

In step 212, the method can process user service interactions through operations including, without limitation, natural language processing of ticket content, issue categorization, and calculation of support-related metrics. The natural language processing pipeline includes text normalization, entity recognition, and sentiment analysis specifically trained on support ticket content. The categorization method can employ a hierarchical classification model that groups issues by product area, severity, and root cause. The method may analyze factors such as ticket volume, resolution times, and user satisfaction scores to identify patterns indicating user health issues. The processor tracks metrics including mean time to resolution, first-response time, escalation rates, and recurring issue patterns. It maintains separate tracking for different issue severities and implements anomaly detection to identify unusual patterns in support interactions.

Finally, in step 214, the method can process financial data by, for example, managing transaction records through operations including, without limitation, revenue calculations, payment pattern analysis, and contract term evaluation. The financial processor implements double-entry validation and reconciliation checks to ensure data accuracy. It calculates various revenue metrics including monthly recurring revenue, expansion revenue, and contraction revenue, with separate tracking for different product lines and billing types. The processor analyzes payment timing patterns to identify changes in payment behavior that might indicate user satisfaction issues. For contract analysis, the processor extracts and tracks key terms including renewal dates, commitment levels, and negotiated terms. The financial processor may generate metrics such as monthly recurring revenue, user lifetime value, and renewal probability based on historical patterns. The probability calculations incorporate both historical payment patterns and terms comparison across the user base to identify risk factors in contract structures.

After source-specific processing, the method proceeds to feature engineering. In step 216, the method can include applying temporal analysis process to the data streams, which examines patterns and trends over time through operations including, without limitation, seasonality detection, growth rate calculation, and change point analysis. The temporal analysis employs multiple statistical techniques operating at different time scales, from daily patterns to quarterly cycles. For seasonality detection, the method applies time series decomposition to separate cyclical patterns from trend components, using configurable window sizes to capture both short-term and long-term cycles. The growth rate calculation implements both point-wise and smoothed rate computations, using techniques such as exponential moving averages with adaptive parameters based on data volatility. Change point analysis can employ algorithms including CUSUM (Cumulative Sum) charts for detecting gradual shifts and Bayesian change point detection for identifying sudden changes in behavior patterns. In some implementations, the temporal analyzer may identify usage patterns aligned with business cycles, such as quarterly financial planning activities. The analyzer maintains separate pattern models for different user segments and product types to account for varying expected usage patterns across different user populations.

In some implementations, temporal pattern extraction is specifically adapted to different product usage cadences. For products with known quarterly usage patterns, such as financial planning applications, the method implements specialized detection for both normal quarterly spikes and deviations from expected periodic behavior. The feature engineering pipeline maintains separate temporal models for different usage frequencies for example, distinguishing between daily active products (like HR systems), weekly active products (like planning tools), and quarterly active products (like budgeting systems).

The seasonality detection method employs multiple time scales of analysis. At the finest granularity, it tracks daily and weekly patterns to establish baseline usage rhythms. At a medium scale, it analyzes monthly and quarterly patterns to identify business cycle effects. At the longest scale, it identifies annual patterns and long-term trends. The method automatically adapts its seasonality detection parameters based on the observed usage frequency of each product and feature, preventing false pattern detection in sparse data.

Feature engineering for temporal patterns includes specialized handling of: usage intensity metrics that account for expected quiet periods, ratio calculations that compare actual versus expected usage for each time period, variance metrics that identify unusual deviations from established patterns, cross-product usage correlations that identify linked usage patterns, time-windowed aggregations at different scales (day, week, month, quarter, year), and temporal sequence detection for complex usage patterns.

The method implements adaptive windowing for feature calculation, where the time windows used for feature engineering automatically adjust based on the underlying data characteristics. For high-frequency data sources, the method may use shorter windows to capture rapid changes in behavior. For sparse data sources, the method automatically extends the window size to ensure sufficient data for reliable feature calculation.

In some implementations, the feature engineering pipeline includes specific handling for lifecycle-dependent features. For example, it generates different features for customers in different stages of their lifecycle (such as onboarding, steady state, or renewal period), recognizing that the significance of usage patterns varies by lifecycle stage. The method maintains separate feature importance rankings for different lifecycle stages, allowing the downstream models to adjust their predictions based on customer context.

In step 218, the method can perform pattern detection, employing various techniques including, without limitation, sequence mining, anomaly detection, and behavioral clustering to identify significant patterns in the processed data. The sequence mining component identifies common sequences of actions and state transitions using algorithms such as PrefixSpan for efficient mining of sequential patterns. The method can employ both statistical methods for univariate metrics and isolation forest techniques for detecting anomalies in high-dimensional feature spaces. Behavioral clustering implements k-means and hierarchical clustering algorithms to group similar usage patterns, with distance metrics optimized for temporal sequences. The pattern detector may discover complex sequences of events that typically precede user churn or expansion decisions, such as decreasing usage frequency followed by increased competitor research activity. The detector maintains separate pattern libraries for different user segments and continuously updates pattern significance scores based on observed outcomes.

In step 220, the method can perform correlation analysis to examine relationships between different metrics and events across data sources through operations including, without limitation, calculating correlation coefficients, performing significance testing, and identifying leading indicators. The method implements both Pearson correlation for linear relationships and Spearman rank correlation for non-linear associations, with time-lagged calculations to detect delayed effects between different metrics. The significance testing employs multiple hypothesis correction to account for the large number of potential correlations being tested. The correlation analyzer may discover relationships such as how changes in web search patterns relate to subsequent changes in product usage or support ticket volume. The method can maintain a correlation matrix across all key metrics and automatically identifies strong correlations that exceed configured threshold values. The analyzer also implements Granger causality testing to identify potential causal relationships between time series, helping to distinguish leading indicators from coincidental correlations.

In step 222, the method can select features by evaluating and selecting the most relevant engineered features through techniques including, without limitation, statistical testing, importance scoring, and wrapper methods. The statistical testing can include both univariate analysis like ANOVA and multivariate techniques such as mutual information scoring to assess feature relevance. Importance scoring combines multiple metrics including feature stability over time, correlation with target variables, and contribution to model performance. The wrapper methods implement forward and backward selection using cross-validation to evaluate feature combinations while preventing overfitting. The selection process considers both predictive power and practical constraints such as computational cost and data availability. The system maintains separate feature importance rankings for different prediction tasks and user segments, updating these rankings as new data becomes available. Features are also evaluated for their reliability and update frequency to ensure the selected feature set can support both batch and real-time prediction scenarios.

In step 224, the method generates feature vectors from the selected features through operations including, without limitation, scaling, normalization, and encoding of categorical variables. The feature vector generation process ensures all features are in the correct format for downstream machine learning models and handles any final preprocessing requirements.

Finally, in step 226, the method stores the generated feature vectors in a feature store for use by downstream processes. The feature store implements versioning and metadata tracking to maintain feature lineage and support reproducibility. In some implementations, the feature store may also implement caching mechanisms to optimize feature serving for both batch and real-time prediction scenarios.

Throughout the entire process, the method maintains detailed logging and error handling capabilities (not shown). Error conditions at any step may trigger retry mechanisms or fallback processing paths to ensure robust operation. The method may operate continuously as new data arrives or run on a scheduled basis depending on implementation requirements. In some implementations, different steps may operate on different schedules. For example, some feature engineering operations might run daily while others operate in real-time. The modular nature of the method allows for flexible scaling and optimization of individual components based on performance requirements and data volumes.

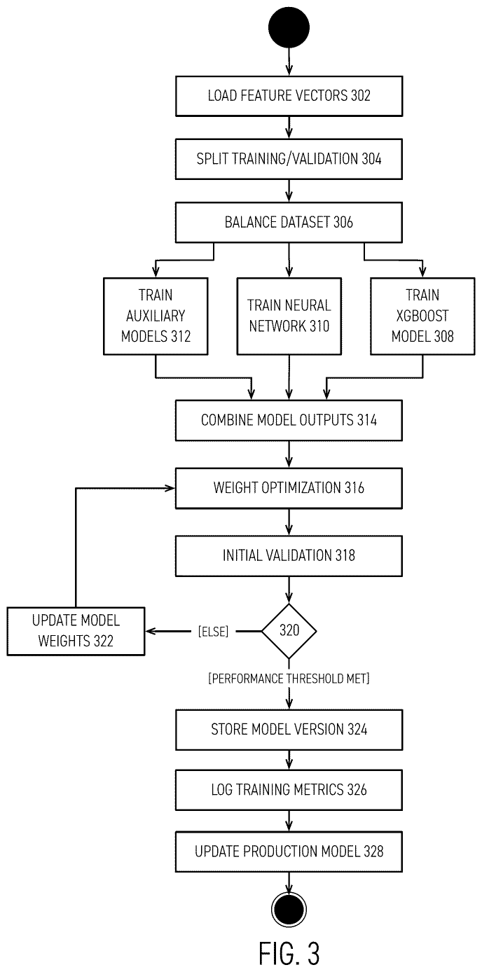

FIG. 3 is a flow diagram illustrating a method for training and deploying user engagement prediction models according to some of the disclosed embodiments.

In step 302, the method begins by loading feature vectors from the feature store. In some implementations, these feature vectors comprise the engineered features generated through the process described in FIG. 2, including temporal patterns, usage metrics, support statistics, and financial indicators. The feature loading process may include operations for ensuring data consistency and handling any missing values that might have occurred since feature generation. The loading process may also perform final feature validation checks, ensuring all features are within expected ranges and follow the required distributions. In some implementations, this step may include feature versioning checks to ensure all features are from compatible versions of the feature engineering pipeline.

In step 304, the method splits the loaded feature vectors into training and validation datasets. In some implementations, this split operation ensures that the model evaluation process uses completely separate data from the training process to provide unbiased performance estimates. The split may be stratified to maintain the same distribution of user characteristics and outcomes across both datasets. In some implementations, the method may also create a separate test set that remains completely unused until final model evaluation. The split ratios may be configurable, but typically follow an 80/10/10 split between training, validation, and test sets. The split process may also ensure that all data from a single user remains in the same split to prevent data leakage.

In step 306, the method performs dataset balancing to address any class imbalance issues. In some implementations, this balancing operation may employ techniques including, without limitation, oversampling minority classes, undersampling majority classes, or synthetic sample generation using SMOTE (Synthetic Minority Oversampling Technique) or similar algorithms. This step is particularly important for user engagement prediction, where the number of churned users may be significantly smaller than the number of retained users. The balancing process may also consider the temporal aspects of the data, ensuring that synthetic samples maintain realistic temporal patterns and relationships between features.

Following data preparation, the method initiates parallel training of multiple models. In step 308, the method trains an XGBoost model, which may be particularly effective at capturing non-linear relationships in user behavior patterns. The XGBoost training process can include hyperparameter optimization through techniques such as grid search or Bayesian optimization to find the optimal model configuration. Key parameters that may be optimized include tree depth, learning rate, number of estimators, and regularization parameters. The training process may also implement early stopping based on validation performance to prevent overfitting.

In some implementations, the method implements specialized handling for imbalanced datasets through multiple complementary approaches. At the data level, the method applies adaptive synthetic sampling techniques that maintain temporal consistency—when generating synthetic examples of rare classes (such as churned customers), the method preserves realistic temporal patterns in the synthetic data. For highly imbalanced situations where the ratio between classes exceeds 20:1, the method employs a cascade of increasingly specialized models, with each stage filtering cases for more detailed analysis by subsequent stages.

The ensemble architecture specifically combines models with different strengths. Tree-based models (such as XGBoost) capture non-linear feature interactions and handle mixed data types efficiently, while neural networks, particularly temporal architectures, capture complex sequential patterns. The method also employs specialized survival analysis models that focus specifically on time-to-event prediction, along with lightweight models optimized for specific customer segments or use cases.

In some implementations, the complementary nature of the model types is specifically engineered to handle different aspects of the prediction task. For example, tree-based models excel at capturing non-linear threshold effects in usage patterns, while neural networks are particularly effective at identifying subtle temporal sequences in user behavior. The survival analysis models provide specialized handling of time-dependent risks, incorporating both static features and time-varying covariates to model the probability of events like customer churn over different time horizons. This complementary approach ensures that each model type contributes unique predictive signals to the ensemble.

Each model type within the ensemble employs specialized training approaches. The XGBoost models use feature-level early stopping to automatically select optimal tree depths for different feature subsets. Neural networks implement custom loss functions that balance multiple prediction objectives. Survival models incorporate time-varying covariates to capture changing risk factors, while segment-specific models employ transfer learning from the general models while maintaining specialization.

The weight optimization process implements safeguards against overfitting to recent data patterns. The method maintains separate validation sets for different time periods and customer segments, ensuring that weight adjustments improve performance consistently across all subgroups. When optimizing ensemble weights, the method considers multiple objectives including overall prediction accuracy, segment-specific performance metrics, prediction latency requirements, feature availability constraints, and explanation quality metrics.

In some implementations, the method employs progressive validation during training, where model performance is continuously evaluated on streaming data to detect concept drift or degradation in prediction quality. This allows for early detection of model staleness and triggers automated retraining when necessary. The progressive validation method maintains separate performance tracking for different customer segments and use cases, enabling targeted retraining of specific model components when performance degrades for particular subgroups.

Simultaneously, in step 310, the method trains a neural network model. In some implementations, this neural network may employ architectures including, without limitation, feed-forward networks, recurrent neural networks, or transformer-based models. The neural network training process may include techniques such as batch normalization, dropout, and learning rate scheduling to improve model convergence and generalization. The architecture may be designed to handle both numerical and categorical features effectively, potentially using embedding layers for high-cardinality categorical variables. The training process may employ techniques like cross-validation to ensure robust performance across different data splits.

In step 312, the method trains additional auxiliary models that may capture different aspects of user behavior. These auxiliary models may include, without limitation, survival analysis models for predicting time-to-churn, clustering models for user segmentation, or dedicated models for specific user segments or products. Each auxiliary model may be optimized independently with its own validation process and performance metrics. These models might focus on specific aspects of user behavior that complement the main models, such as seasonal patterns or user lifecycle stages.

The method then proceeds to ensemble creation, beginning with step 314, which combines the outputs from all trained models. In some implementations, this combination may use techniques including, without limitation, weighted averaging, stacking, or model-specific combination rules. The combination process may account for each model's strengths in different prediction scenarios. The ensemble may also implement dynamic weighting schemes that adjust based on the confidence levels of individual model predictions or the characteristics of specific users.

In step 316, the method performs weight optimization for the ensemble. This optimization process adjusts the contribution of each model to the final prediction, potentially using techniques such as gradient descent or evolutionary algorithms to find optimal weights. The optimization may consider multiple objectives, such as overall accuracy, false positive rates, and prediction latency. The weight optimization process may also include constraints to ensure reasonable prediction bounds and prevent any single model from dominating the ensemble predictions.

In step 318, the method performs initial validation occurs, where the method evaluates the ensemble's performance on the validation dataset. This validation step calculates various performance metrics including, without limitation, accuracy, precision, recall, area under the ROC curve, and calibration metrics. The validation process may also analyze performance across different user segments to ensure consistent prediction quality. Additional validation may include stress testing with artificially perturbed data to assess model robustness.

In step 320, the method checks whether the model meets predefined performance thresholds. These thresholds may include both overall performance metrics and specific requirements for different user segments or prediction types. The thresholds might vary by user size, industry, or product line to ensure appropriate prediction quality for different business contexts. If the thresholds are not met, the method proceeds to step 322, which updates the model weights based on the validation results and returns to the weight optimization step for further refinement.

When performance thresholds are met, the method proceeds to step 324, which stores the validated model version. The storage process includes saving model parameters, preprocessing configurations, ensemble weights, and complete training metadata. In some implementations, the storage system maintains a complete version history to support rollback capabilities if needed. The storage process may also include compression of model artifacts to minimize storage requirements while maintaining quick loading capabilities for inference.

In step 326, the method logs detailed training metrics, including model performance statistics, training duration, and resource utilization. These logs support both immediate deployment decisions and longer-term analysis of model development patterns. The logging process may integrate with existing monitoring and alerting systems to notify relevant stakeholders of training completion or issues. The logs may include detailed performance breakdowns by user segment, feature importance analyses, and model interpretation metrics.

Finally, in step 328, the method updates the production model with the new version. This update process may include atomic replacement of the existing model to ensure consistent predictions during the transition. In some implementations, the method may employ techniques such as shadow deployment or A/B testing to validate the new model's performance in production before full deployment. The deployment process may include warm-up periods where the new model runs in parallel with the existing model to ensure stability and performance under production loads.

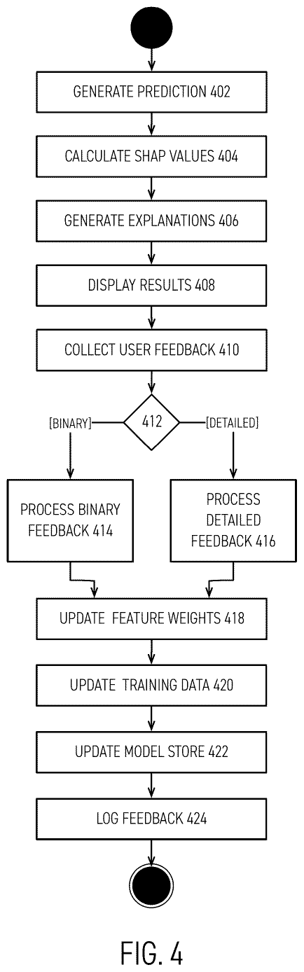

FIG. 4 is a flow diagram illustrating a method for generating and explaining user engagement predictions according to some of the disclosed embodiments.

In step 402, the method generates predictions using the trained ensemble model described in FIG. 3. In some implementations, prediction generation includes loading the current model version from the model store, retrieving recent feature vectors for the target users, and executing the ensemble model to generate engagement scores. The prediction process may handle both batch predictions for regular reporting and real-time predictions for immediate analysis. For batch predictions, the system may implement optimizations such as parallel processing and batch size tuning to maximize throughput. Real-time predictions may employ caching strategies and pre-computed features to minimize latency.

In step 404, the method calculates SHAP (SHapley Additive exPlanations) values for the predictions. In some implementations, this calculation determines the contribution of each input feature to the final prediction score. The SHAP calculation process may employ optimization techniques to handle the computational complexity of exact Shapley calculations, particularly for ensemble models. In some implementations, the method may use techniques such as kernel SHAP or Tree SHAP depending on the underlying model architecture. For tree-based models like XGBoost, Tree SHAP provides efficient exact calculations, while kernel SHAP may be used for neural network components of the ensemble. The method may also implement approximation techniques for real-time explanation generation where exact SHAP calculations would be too time-consuming.

In step 406, the method generates natural language explanations based on the SHAP values. These explanations translate the mathematical feature contributions into human-readable insights about why particular predictions were made. In some implementations, the explanation generator may use templates or natural language generation models to create context-appropriate explanations that highlight the most significant factors affecting each prediction. The explanations may be tailored to different user roles, with technical users receiving more detailed feature-level explanations while business users receive higher-level strategic insights. The explanation generator may also incorporate domain-specific language and terminology relevant to user engagement analysis.

In step 408, the method displays the predictions and explanations through appropriate user interfaces. The display may include interactive visualizations of feature contributions, allowing users to explore different aspects of the predictions. In some implementations, the interface may support different views optimized for various user roles, such as executive summaries or detailed analytical views. The visualization may include components such as waterfall charts showing cumulative feature impacts, force plots displaying feature interactions, and temporal views showing prediction changes over time. The interface may also provide drill-down capabilities to explore specific user segments or time periods in detail.

In some implementations, the method implements a multi-tiered feedback processing architecture that handles both structured and unstructured feedback inputs. The binary feedback processor handles simple positive/negative responses through a weighted accumulation method, where feedback is weighted based on factors including the recency of the prediction, the historical accuracy of the feedback provider, and the significance of the prediction. This binary feedback directly influences the confidence thresholds used in the prediction method, automatically adjusting them based on observed false positive and false negative rates across different customer segments.

The detailed feedback processor employs natural language processing to analyze unstructured feedback, extracting specific critiques about feature relevance and prediction rationale. The method maintains a feedback knowledge base that tracks common patterns in user feedback, helping to identify systematic issues in the prediction logic. When processing detailed feedback, the method distinguishes between feedback about the prediction itself and feedback about the explanation quality, allowing separate optimization of the prediction and explanation components.

The feedback integration method implements several safeguards to maintain method stability. Before applying any feedback-driven changes, the method validates the proposed adjustments against historical performance data to ensure they don't degrade prediction quality for other customer segments. The method employs a graduated update scheme where feedback-driven changes are first applied with limited weight and gradually increased based on validated performance improvements. This prevents individual feedback instances from causing dramatic method changes while still allowing the method to adapt to changing patterns over time.

The feedback integration system implements multiple layers of stability controls. At the lowest level, individual feedback instances are weighted based on their consistency with historical patterns and the feedback provider's historical accuracy. At the intermediate level, feedback-driven changes are subjected to A/B testing on holdout datasets before being incorporated into the production model. At the highest level, the system maintains separate feedback accumulation thresholds for different types of model changes-for example, requiring more consensus feedback before modifying core feature weights than for adjusting prediction thresholds. This multi-layered approach prevents both rapid oscillations from conflicting feedback and gradual drift from systematic bias in the feedback process.

In some implementations, the method maintains separate feedback processing pipelines for different user roles. Feedback from technical users might directly influence feature engineering and model parameters, while feedback from business users might focus more on explanation quality and prediction thresholds. The method also implements feedback conflict resolution, where contradictory feedback from different sources is reconciled based on historical feedback accuracy and user expertise levels.

The feedback method includes an automated monitoring component that tracks the impact of feedback-driven changes over time. This monitoring method maintains metrics about feedback utilization rates, the distribution of feedback across different prediction types and customer segments, and the correlation between feedback-driven changes and subsequent prediction accuracy. When feedback patterns indicate potential issues with specific features or model components, the method can automatically trigger more detailed analysis or suggest model retraining.

In step 410, the method collects user feedback on the predictions and explanations. The feedback collection interface may provide multiple channels for users to respond to the system's outputs. This may include both structured feedback mechanisms (such as rating scales or pre-defined categories) and unstructured feedback (such as free-form comments or annotations). The feedback system may support both immediate reactions to predictions and longer-term tracking of prediction accuracy as outcomes become known. Users may also provide feedback on specific features or feature combinations that they believe are particularly important or potentially misleading.

The method proceeds to step 412, which determines the type of feedback received. In some implementations, the method distinguishes between binary feedback (simple approve/reject responses) and detailed feedback (specific comments about features or explanations). This classification helps route the feedback through appropriate processing paths for maximum impact on system improvement. The feedback classifier may employ natural language processing to categorize free-form feedback and extract specific actionable items.

For binary feedback (step 414), the method processes simple positive or negative responses about prediction accuracy. This processing may include aggregating feedback across multiple users and identifying patterns in prediction performance. In some implementations, the binary feedback processor may maintain separate tracking for different user segments or prediction types. The system may use this feedback to calculate user-specific confidence scores for predictions and adjust how predictions are presented to different users.

For detailed feedback (step 416), the method processes specific comments and suggestions about the predictions and explanations. This may include natural language processing to extract actionable insights from user comments, categorization of feedback types, and identification of common themes or issues. The detailed feedback processor may also track feature-specific feedback to inform feature engineering improvements. The system may maintain a knowledge base of feedback patterns to identify recurring issues or suggestions for system improvement.

In step 418, the method updates feature weights based on the processed feedback. This update process may adjust the importance assigned to different features in the prediction model based on user insights. In some implementations, the weight updates may be reviewed and validated before being applied to ensure system stability. The weight updating process may include safeguards to prevent dramatic changes based on limited feedback and may require consensus across multiple users before making significant adjustments.

The method continues to step 420, which updates the training data based on the feedback. This may include incorporating corrected labels, adding new examples to the training set, or adjusting sample weights based on feedback patterns. The training data updates are carefully managed to maintain data quality and prevent feedback loops that could bias the system. The update process may include validation steps to ensure new training examples are consistent with existing data and don't introduce unwanted biases.

In step 422, the method updates the model store with any changes resulting from the feedback processing. This includes storing updated feature weights, modified training data, and any new model versions generated in response to feedback. The model store update process maintains version control and ensures traceability of changes. Each update is logged with metadata about the feedback that triggered it, enabling analysis of how feedback influences model evolution over time.

Finally, in step 424, the method logs all feedback and resulting changes for analysis and auditing purposes. The logging process captures both the raw feedback and the actions taken in response, supporting continuous improvement of the prediction system. In some implementations, the logs may be analyzed to identify trends in feedback patterns and evaluate the effectiveness of the feedback incorporation process. The logging system may also track metrics about feedback utilization, such as the percentage of feedback items that led to concrete system improvements.

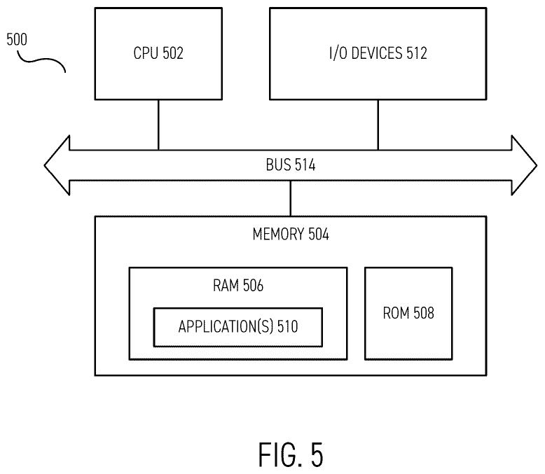

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving data from a plurality of heterogeneous data sources;
processing each type of received data through a corresponding type-specific processing pipeline by performing temporal pattern extraction specific to each data type;
generating cross-source feature vectors by performing temporal correlation analysis across the processed data from different data sources;
training an ensemble machine learning model using the cross-source feature vectors;
generating engagement predictions and feature contribution values that quantify an impact of each feature on each prediction;
presenting the engagement predictions with natural language explanations based on the feature contribution values; and
updating weights of the ensemble machine learning model based on user feedback regarding the natural language explanations.

2. The method of claim 1, wherein processing each type of received data comprises: extracting time-based behavioral patterns specific to each data source type; generating source-specific engagement metrics; and normalizing the metrics across different time scales.

3. The method of claim 1, wherein generating cross-source feature vectors comprises: identifying correlations between events across different data sources; detecting temporal sequences that span multiple data sources; and generating features that capture cross-source interaction patterns.

4. The method of claim 1, wherein training the ensemble machine learning model comprises: training multiple model types optimized for different aspects of user behavior; combining outputs of the models using dynamically adjusted weights; and validating combined model performance across different user segments.

5. The method of claim 1, wherein generating the feature contribution values comprises: calculating an impact of each feature on the prediction; aggregating feature impacts across different time windows; and generating relative importance rankings for features from each data source.

6. The method of claim 1, wherein updating weights of the ensemble model comprises: processing structured and unstructured user feedback on the explanations; adjusting feature importance weights based on the processed feedback; and retraining the ensemble model using the adjusted weights.

7. The method of claim 1, wherein presenting the engagement predictions with natural language explanations comprises: generating a set of explanation templates for different prediction types; selecting relevant templates based on prediction context and user role; populating the selected templates with feature contribution values and temporal context; generating visualizations showing cumulative feature impacts; and providing interactive drill-down capabilities for exploring feature relationships across different time periods.

8. A non-transitory computer-readable storage medium for tangibly storing computer program instructions capable of being executed by a computer processor, the computer program instructions defining steps of:
receiving data from a plurality of heterogeneous data sources;
processing each type of received data through a corresponding type-specific processing pipeline by performing temporal pattern extraction specific to each data type;
generating cross-source feature vectors by performing temporal correlation analysis across the processed data from different data sources;
training an ensemble machine learning model using the cross-source feature vectors;
generating engagement predictions and feature contribution values that quantify an impact of each feature on each prediction;
presenting the engagement predictions with natural language explanations based on the feature contribution values; and
updating weights of the ensemble machine learning model based on user feedback regarding the natural language explanations.

9. The non-transitory computer-readable storage medium of claim 8, wherein processing each type of received data comprises: extracting time-based behavioral patterns specific to each data source type; generating source-specific engagement metrics; and normalizing the metrics across different time scales.

10. The non-transitory computer-readable storage medium of claim 8, wherein generating cross-source feature vectors comprises: identifying correlations between events across different data sources; detecting temporal sequences that span multiple data sources; and generating features that capture cross-source interaction patterns.

11. The non-transitory computer-readable storage medium of claim 8, wherein training the ensemble machine learning model comprises: training multiple model types optimized for different aspects of user behavior; combining outputs of the models using dynamically adjusted weights; and validating combined model performance across different user segments.

12. The non-transitory computer-readable storage medium of claim 8, wherein generating the feature contribution values comprises: calculating an impact of each feature on the prediction; aggregating feature impacts across different time windows; and generating relative importance rankings for features from each data source.

13. The non-transitory computer-readable storage medium of claim 8, wherein updating weights of the ensemble model comprises: processing structured and unstructured user feedback on the explanations; adjusting feature importance weights based on the processed feedback; and retraining the ensemble model using the adjusted weights.

14. The non-transitory computer-readable storage medium of claim 8, wherein presenting the engagement predictions comprises: generating different levels of explanation detail for different user types; highlighting most significant cross-source patterns; and providing interactive exploration of feature contributions.

15. A device comprising:
a processor; and
a storage medium for tangibly storing thereon program logic for execution by the processor, the program logic comprising steps for:
receiving data from a plurality of heterogeneous data sources;
processing each type of received data through a corresponding type-specific processing pipeline by performing temporal pattern extraction specific to each data type;
generating cross-source feature vectors by performing temporal correlation analysis across the processed data from different data sources;
training an ensemble machine learning model using the cross-source feature vectors;
generating engagement predictions and feature contribution values that quantify an impact of each feature on each prediction;
presenting the engagement predictions with natural language explanations based on the feature contribution values; and
updating weights of the ensemble machine learning model based on user feedback regarding the natural language explanations.

16. The device of claim 15, wherein processing each type of received data comprises: extracting time-based behavioral patterns specific to each data source type; generating source-specific engagement metrics; and normalizing the metrics across different time scales.

17. The device of claim 15, wherein generating cross-source feature vectors comprises: identifying correlations between events across different data sources; detecting temporal sequences that span multiple data sources; and generating features that capture cross-source interaction patterns.

18. The device of claim 15, wherein training the ensemble machine learning model comprises: training multiple model types optimized for different aspects of user behavior; combining outputs of the models using dynamically adjusted weights; and validating combined model performance across different user segments.

19. The device of claim 15, wherein generating the feature contribution values comprises: calculating an impact of each feature on the prediction; aggregating feature impacts across different time windows; and generating relative importance rankings for features from each data source.

20. The device of claim 15, wherein updating weights of the ensemble model comprises: processing structured and unstructured user feedback on the explanations; adjusting feature importance weights based on the processed feedback; and retraining the ensemble model using the adjusted weights.
